(19) United States
(12) Patent Application Publication
(10) Pub. No.: US 2024/0028452 A1
(43) Pub. Date: Jan. 25, 2024

(54) FAULT-MITIGATING METHOD AND DATA PROCESSING CIRCUIT

(71) Applicant: Skymizer Taiwan Inc., Taipei City (TW)

(72) Inventors: Shu-Ming Liu, Taipei City (TW); Kai-Chiang Wu, Hsinchu (TW); Wen Li Tang, Taipei City (TW)

(73) Assignee: Skymizer Taiwan Inc., Taipei City (TW)

(21) Appl. No.: 18/162,601

(22) Filed: Jan. 31, 2023

(30) Foreign Application Priority Data
Jul. 25, 2022 (TW) 111127827

(51) Int. Cl. G06F 11/10

(52) U.S. Cl. CPC G06F 11/104

(57) ABSTRACT

A data processing circuit and a fault-mitigating method are provided. A first data is written into a memory. A computed result is determined according to one or more adjacent bits of the first data at faulty bits. According to the computed result, new values are determined. The new values replace the values of the first data at the faulty bits to form a second data. The first data includes multiple bits. The first data is image-related data, weights used by a multiply-accumulate (MAC) for extracting features of images, and/or values used by an activation calculation. The adjacent bits are adjacent to the faulty bits. The computed result is obtained through computing the values of the first data at non-faulty bits of the memory. Accordingly, an influence of a memory fault is reduced.

### CROSS-REFERENCE TO RELATED APPLICATION

This application claims the priority benefit of Taiwan application serial no. 111127827, filed on Jul. 25, 2022. The entirety of the above-mentioned patent application is hereby incorporated by reference herein and made a part of this specification.

### BACKGROUND

### Technical Field

The present disclosure relates to a data processing mechanism, and more particularly, to a fault-mitigating method and a data processing circuit.

### Description of Related Art

Neural network is an important theme in artificial intelligence (AI), which makes decisions through simulating operations of human brain cells. It is worth noting that there are many neurons in the human brain cells, and these neurons are connected to each other through synapse. Among them, each of the neurons receive signals via the synapse, and a converted output of the signal will be transmitted to another neuron. The conversion ability of each of the neurons is different, and through operations of the aforementioned signal transmission and conversion, human beings form an ability to think and judge. The neural network obtains the corresponding ability according to the aforementioned operation method.

The neural network is often used in image recognition. In the operation of each of the neurons, an input component and a weight of the corresponding synapse are multiplied (possibly with a bias) and then output through a calculation of a nonlinear function (e.g. activation function) to extract image features. Inevitably, a memory for storing input values, weight values, and function parameters may cause some storage blocks to fault/damage (e.g. hard error) due to poor yields, thereby affecting the completeness or correctness of a stored data. Even for a convolutional neural network (CNN), after executing a convolution calculation, the faulty/damaged situation will seriously affect image recognition results. For example, if the fault occurs in higher bits, the recognition success rate may approach zero.

### SUMMARY

In light of the foregoing, embodiments of the present disclosure provide a fault-mitigating method and a data processing circuit, which replace data based on statistical characteristics of adjacent features to improve recognition accuracy.

The fault-mitigating method of the embodiment of the present disclosure is suitable for a memory having faulty bits. The fault-mitigating method includes (but is not limited to) the following. A first data is written into the memory. A computed result is determined according to one or more adjacent bits of the first data at the faulty bits. According to the computed result, new values are determined. The new values replace the values of the first data at the faulty bits to form a second data. The first data includes multiple bits. The first data is image-related data, weights used by a multiply-accumulate (MAC) for extracting features of images, and/or values used by an activation calculation. The adjacent bits are adjacent to the faulty bits. The computed result is obtained through computing the values of the first data at non-faulty bits of the memory.

The data processing circuit of the embodiment of the present disclosure includes (but is not limited to) a memory and a processor. The memory is used for storing codes and has one or more faulty bits. The processor is coupled to the memory and is configured to load and execute the following steps. A first data is written into the memory. A computed result is determined according to one or more adjacent bits of the first data at the faulty bits. According to the computed result, new values are determined. The new values replace the values of the first data at the faulty bits to form a second data. The first data includes multiple bits. The first data is image-related data, weights used by a MAC for extracting features of images, and/or values used by an activation calculation. The adjacent bits are adjacent to the faulty bits. The computed result is obtained through computing the values of the first data at non-faulty bits of the memory.

Based on the above, the fault-mitigating method and the data processing circuit of the embodiments of the present disclosure use the computed result of the values at the non-faulty bits to replace the values at the faulty bits. Accordingly, an error rate of image recognition is reduced, thereby reducing the influence of faults.

In order to make the above-mentioned features and advantages of the disclosure clearer and easier to understand, the following embodiments are given and described in details with accompanying drawings as follows.

### BRIEF DESCRIPTION OF THE DRAWING

FIG. 1 is a component block diagram of a data processing circuit according to an embodiment of the present disclosure.

FIG. 2 is a flowchart of a fault-mitigating method according to an embodiment of the present disclosure.

FIG. 3 is a correspondence diagram of fault locations and probabilities according to an embodiment of the present disclosure.

FIG. 4A is an example illustrating correct data stored in a normal memory.

FIG. 4B is an example illustrating data stored in a faulty memory.

FIG. 4C is an example illustrating data replaced by use of a computed result.

FIG. 5 is another example illustrating data replaced by use of a computed result.

### DESCRIPTION OF THE EMBODIMENTS

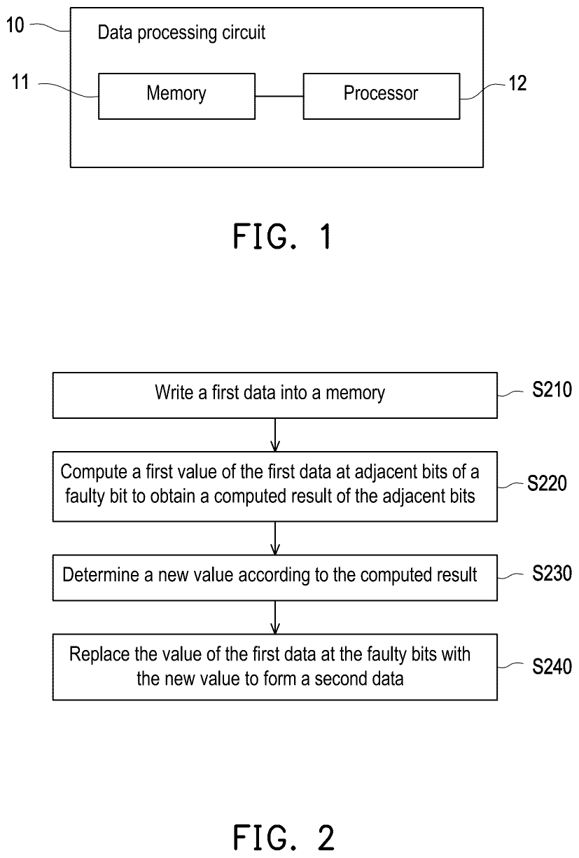

FIG. 1 is a component block diagram of a data processing circuit 10 according to an embodiment of the present disclosure. Referring to FIG. 1, the data processing circuit 10 includes (but is not limited to) a memory 11 and a processor 12.

The memory 11 may be a static or a dynamic random access memory (RAM), a read-only memory (ROM), a flash memory, a register, a combinational circuit or a combination of the above components. In an embodiment, the memory 11 is used for storing image-related data, weights used by a MAC for extracting features of images, and/or values used by an activation calculation, a pooling calculation, and/or other neural network calculations. In other embodiments, users may determine the type of data stored in the memory 11 according to actual needs.

In an embodiment, the memory 11 is used to store codes, software modules, configurations, data or files (e.g. neural network related parameters, computed results), which will be described in details in subsequent embodiments.

In some embodiments, the memory 11 has one or more faulty bits. The faulty bits refer to faults/damages of the bits due to process errors or other factors (may be called hard error or permanent fault), which causes access results to be different from actual stored contents. The faulty bits have been detected in advance, and location information of the faulty bits in the memory 11 is available to the processor 12 (via a wired or wireless transmission interface). On the other hand, the bits in the memory 11 without faults/damages due to process errors or other factors are referred to as non-faulty bits. That is, non-faulty bits are not faulty bits.

The processor 12 is coupled to the memory 11. The processor 12 may be a circuit composed of multiplexers, adders, multipliers, encoders, decoders, or one or more of various types of logic gates, and may be central processing units (CPUs), graphic processing units (GPUs), or other programmable general-purpose or special-purpose microprocessors, digital signal processors (DSPs), programmable controllers, field programmable gate arrays (FPGAs), application-specific integrated circuits (ASICs), neural network accelerators or other similar components or a combination of the above components. In an embodiment, a processor 10 is configured to execute all or part of operations of the data processing circuit 10, and load and execute various software modules, codes, files and data stored in the memory 11. In some embodiments, operations of the processor 12 is implemented through software.

It should be noted that a data processing circuit 100 is not limited to applications of a deep learning accelerator 200 (e.g. inception_v3, resnet101 or resnet152), and may be applied in any technical field requiring MACs.

In the following, a method according to an embodiment of the present disclosure will be described with reference to various components or circuits in the data processing circuit 100. Each process of the method may be adjusted according to the implementation situation, and is not limited hereto.

FIG. 2 is a flowchart of a fault-mitigating method according to an embodiment of the present disclosure. Referring to FIG. 2, a processor 12 writes a first data into a memory 11 (step S210). Specifically, the first data is, for example, image-related data (e.g. grayscale values of pixels, eigenvalues), weights used by a MAC, or values used by an activation calculation. Alternatively, the first data is a neural network related parameter. The values in the first data are ordered according to specific rules (e.g. pixel location, convolution kernel definition location, calculation order). The first data includes multiple bits. Numbers of bits of a piece of the first data may be equal to or smaller than numbers of bits used for storing data in a certain sequence block of the memory 11, e.g. the numbers of bits are 8, 12, or 16 bits. For example, a piece of the first data is 16-bit weight. The 16-bit weight will be multiplied by the 16-bit feature in a one-bit-to-one-bit corresponding manner.

The memory 11 with one or more faulty bits provides one or more blocks for the first data or other data to store. The blocks are used for storing input parameters and/or output parameters (e.g. features maps or weights) of the neural network. The neural network is any version of Inception, GoogleNet, ResNet, AlexNet, SqueezeNet or other models. The neural network includes one or more layers of calculation. The calculation layer may be a convolutional layer, an activation layer, a pooling layer, or other neural network related layers.

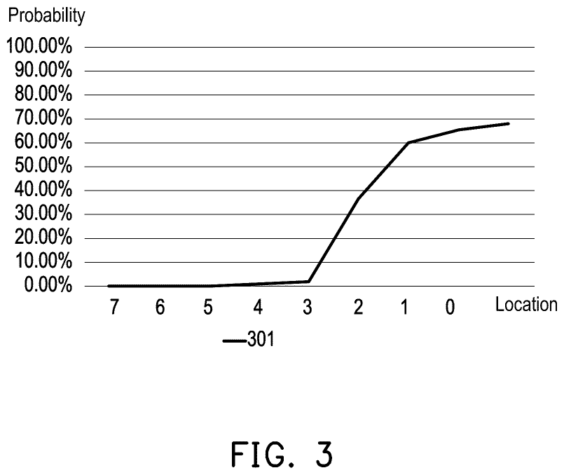

If the first data is stored in the faulty bits of the memory 11, it may affect subsequent recognition or prediction results of the neural network. As an example, FIG. 3 is a correspondence diagram of fault locations and probabilities according to an embodiment of the present disclosure. Referring to FIG. 3, taking Inception version 301 as an example, if the location of the faulty bits in the data is different, accuracy of the prediction result of the neural network may also be different, according to experimental results. For example, if the faulty bits occur in higher bits in the data, the recognition success rate may approach zero. And if the fault occurs in the lowest bit in the data, the recognition success rate may still be 60%.

A processor 12 determines a computed result according to one or more adjacent bits of the first data at the faulty bits (step S220). Specifically, one or more bits of the first data are stored in the faulty bits of the memory 11. The adjacent bits are adjacent to the faulty bits. That is, the adjacent bits are bits located one bit higher than the faulty bits or bits located one bit lower than the faulty bits.

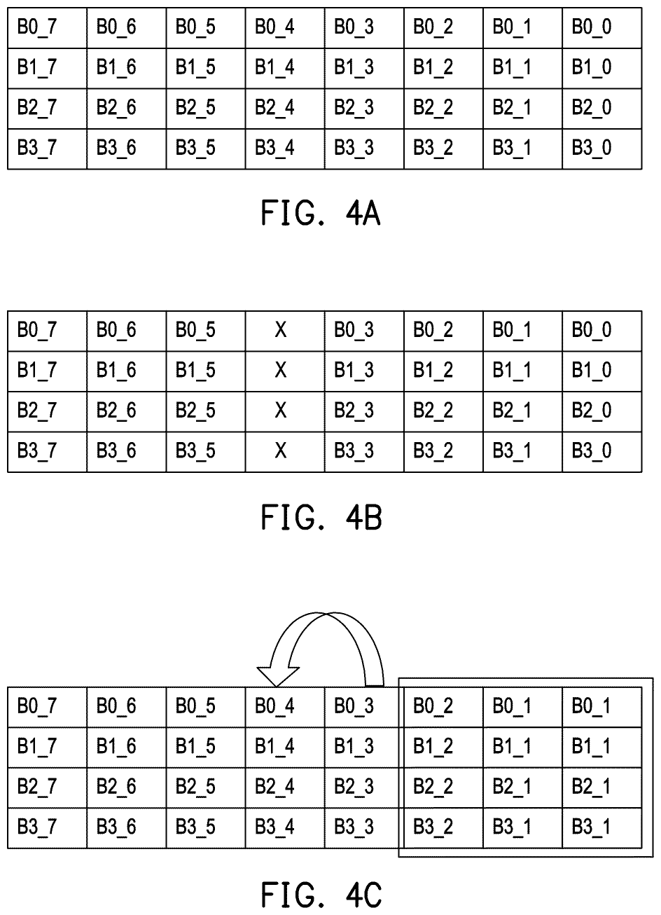

As an example, FIG. 4A is an example illustrating correct data stored in a normal memory. Referring to FIG. 4A, assume the normal memory has no faulty bits. The normal memory records four pieces of the first data (including values B0_0˜B0_7, B1_0˜B1_7, B2_0˜B2_7 and B3_0˜B3_7, and one piece of the first data includes 8 bits). An order here refers to the values B0_0, B0_1, B0_2, . . . , B0_7 ordered from the lowest bit to the highest bit, and so forth.

FIG. 4B is an example illustrating data stored in a faulty memory. Referring to FIG. 4B, assume faulty bits (indicated by “X”) of the faulty memory are located at the fourth bit. If four pieces of sequence data in FIG. 4A are written into the faulty memory, a value B0_0 is stored in the zeroth bit, a value B0_1 is stored in the first bit, and so forth. Furthermore, the values B0_4, B1_4, B2_4 and B3_4 are written into the faulty bits. That is, the values of the fourth bit are written into the faulty bits of the fourth bit. If the faulty bits are accessed, correct values may not be obtained. Adjacent bits are, for example, the third bit (corresponding to values B0_3, B1_3, B2_3 and B3_3) and/or the fifth bit (corresponding to values B0_5, B1_5, B2_5 and B3_5).

According to experimental results, for image recognition or related applications, if values on non-faulty bits are replaced with/regarded as/replaced with the values at the faulty bits, it will help to improve accuracy or prediction ability. A computed result is obtained through computing values of a first data at the non-faulty bits of a memory 11. That is, a processor 12 performs calculations on the values at the non-faulty bits to obtain the computed result.

In an embodiment, the processor 12 obtains a first value of the first data at one or more evaluation bits. The evaluation bits are located at the lower bits of the adjacent bits. As an example, FIG. 4C is an example illustrating data replaced by use of a computed result. Referring to FIG. 4C, faulty bits are the fourth bit, and the adjacent bits are the third bit. The evaluation bits are the second bit (corresponding to values B0_2, B1_2, B2_2 and B3_2), the first bit (corresponding to values B0_1, B1_1, B2_1 and B3_1) and the zeroth bit (corresponding to values B0_0, B1_0, B2_0 and B3_0).

The processor 12 adds the first value at the evaluation bits to a random number. A carry result after adding the random number is the computed result. It is worth noting that applying stochastic rounding to block floating point (BFP) helps to minimize impacts of rounding and thus reduce losses. For example, mantissa and stochastic noise are added to shorten the mantissa of the BFP. Furthermore, since similarity/correlation between adjacent features of images is high, introducing stochastic noise to the adjacent bits helps to predict the values at the faulty bits. The carry result includes carry or no carry from adjacent bits located at the higher bits of the evaluation bits.

Taking FIG. 4C as an example, the second bit (corresponding to the values B0_2, B1_2, B2_2 and B3_2), the first bit (corresponding to the values B0_1, B1_1, B2_1 and B3_1) and the zeroth bit (corresponding to the values B0_0, B1_0, B2_0 and B3_0) are added to a random value of three bits. For example, adding “111” and “001” results in a carry in the third bit. As another example, if “001” and “001” are added, there is no carry in the third bit.

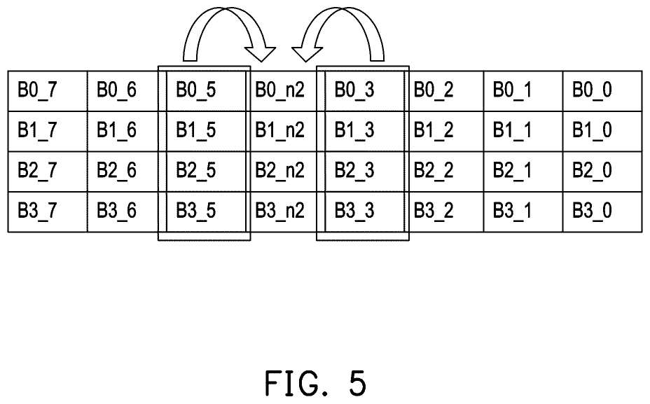

In another embodiment, the adjacent bits include the higher bits and the lower bits adjacent to the faulty bits. For example, FIG. 5 is another example illustrating data replaced by use of a computed result. Referring to FIG. 5, the faulty bits are the fourth bit. The adjacent bits are the third bit (corresponding to values B0_3, B1_3, B2_3 and B3_3) and the fifth bit (corresponding to values B0_5, B1_5, B2_5 and B3_5). That is, the adjacent bits are one bit higher than the faulty bits and one bit one bit lower than the faulty bits.

The processor 12 determines a statistical value of the values of the first data at the higher bits and the lower bits. The statistical value is the computed result. The statistical value may be an arithmetic mean or a weighted calculation of the values of the first data at the higher bits and the lower bits. The experimental results show that there is still a certain degree of similarity or correlation between the values of a certain bit and a plurality of adjacent bits of the certain bit. Therefore, the values at the faulty bits may be predicted with reference to more adjacent bits.

In other embodiments, the computed result may also be other mathematical calculations.

Referring to FIG. 2, the processor 12 determines new values according to a computed result (step S230). Specifically, in the embodiment of adding random numbers, the processor 12 determines the new values to be “1” in response to the computed result being carried to adjacent bits. On the other hand, the processor 12 determines the new values to be “0” in response to the computed result not being carried to adjacent bits. For example, if “101” is added to “011”, the new values are “1”. As another example, if “000” is added to “101”, the new values are “0”.

In the embodiment of the statistical value, the processor 12 directly regards the statistical value as the new values. For example, the arithmetic mean of “0” and “1” is “0”. In another example, the arithmetic mean of “1” and “1” is “1”.

The processor 12 replaces the values of the first data at the faulty bits with the new values to form a second data (step S240). Specifically, the processor 12 accesses data as input data to a multiplier-adder or other calculation units if there is MAC or other requirements. It is worth noting that the processor 12 ignores accessing the values on one or more faulty bits in the memory 11 because the faulty values will be accessed from the faulty bits. Taking FIG. 4B as an example, the processor 12 disables access to the faulty bits (that is, the fourth bit). Alternatively, the processor 12 still accesses the values at the faulty bits, but disables subsequent multiply-add or neural network related calculations on the values which is at the faulty bits. For the values at the faulty bits, the processor 12 directly replaces the values at the faculty bits with the new values based on the computed result.

That is, if there is a demand for access, the processor 12 obtains the second data. The second data is the first data, but the values corresponding to the faulty bits is changed to the new values, while the values corresponding to the non-faulty bit remains unchanged. Taking FIG. 4B and FIG. 4C as an example, values B0_n1, B1_n1, B2_n1 and B3_n1 of the fourth bit in the second data are the same as the new values (not shown in the figures), and the values of other bits in the second data are the same as the values in the same location in the first data. Taking FIG. 4B and FIG. 5 as an example, the values B0_n1, B1_n1, B2_n1 and B3_n1 of the fourth bit in the second data are the same as the new values.

It should be noted that “replacement” in the context means that when some bits in the first data are stored in the faulty bits, the processor 12 ignores reading the values at the faulty bits and directly uses the new values as the values at the faulty bits. However, the values stored in the faulty bits is not stored in the non-faulty bits. For example, if the faulty bits are the second location, the processor 12 replaces the values of the second location with the new values, and disables/stops/does not read the values of the second location. At this time, the values of the second location in the second data read by the processor 12 are the same as the new values.

To sum up, in the data processing circuit and the fault-repairing method of the embodiments of the present disclosure, the new values for replacing the faulty bits are determined according to the computed result of the values of the adjacent non-faulty bits. Accordingly, the error rate of the prediction result of the neural network is reduced.

Although the present disclosure has disclosed the embodiments in the above, it is not intended to limit the present disclosure. Those skilled in the art can make some changes and modifications without departing from the spirit and the scope of the present disclosure. The protection scope of the present disclosure shall be determined by the claims appended in the following.

What is claimed is:

1. A fault-mitigating method suitable for a memory having a faulty bit, comprising:
writing a first data into the memory, wherein the first data comprises a plurality of bits, and the first data is at least one of image-related data, weights used by a MAC (Multiply Accumulate) for extracting features of the image, or values used by an activation calculation;
determining a computed result according to at least one adjacent bit of the first data at the faulty bit, wherein the at least one adjacent bit is adjacent to the faulty bit, and the computed result is obtained through computing a value of the first data at a non-faulty bit of the memory;
determining a new value according to the computed result; and
replacing a value of the first data at the faulty bit with the new value to form a second data.

2. The fault-mitigating method according to claim 1, wherein determining the computed result comprises:
obtaining a first value of the first data at at least one evaluation bit, wherein the at least one evaluation bit is located in a lower bit of the adjacent bit; and
adding the first value at the at least one evaluation bit to a random number, wherein a carry result after adding the random number is the computed result.

3. The fault-mitigating method according to claim 2, wherein determining the new value according to the computed result comprises:
determining the new value to be “1” in response to the computed result being carried to the adjacent bit; and
determining the new value to be “0” in response to the computed result not being carried to the adjacent bit.

4. The fault-mitigating method according to claim 1, wherein the at least one adjacent bit comprises a higher bit and a lower bit adjacent to the faulty bit, and the calculation performed comprises:
determining a statistical value of a value of the first data at the higher bit and the lower bit, wherein the statistical value is the computed result.

5. The fault-mitigating method according to claim 4, wherein the statistical value is an arithmetic mean.

6. A data processing circuit, comprising:
a memory, configured to store a code and having a faulty bit; and
a processor, coupled to the memory, configured to load and execute the code to:
write a first data into the memory, wherein the first data comprises a plurality of bits, and the first data is at least one of image-related data, weights used by a MAC for extracting features of the image, or values used by an activation calculation;
determine a computed result according to at least one adjacent bit of the first data at the faulty bit, wherein the at least one adjacent bit is adjacent to the faulty bit, and the computed result is obtained through computing a value of the first data at a non-faulty bit of the memory;
determine a new value according to the computed result; and
replace a value of the first data at the faulty bit with the new value to form a second data.

7. The data processing circuit according to claim 6, wherein the processor is further configured to:
obtain a first value of the first data at at least one evaluation bit, wherein the at least one evaluation bit is located at a lower bit of the adjacent bit; and
add the first value at the at least one evaluation bit to a random number, wherein a carry result after adding the random number is the computed result.

8. The data processing circuit according to claim 7, wherein the processor is further configured to:
determine the new value to be “1” in response to the computed result being carried to the adjacent bit; and
determine the new value to be “0” in response to the computed result not being carried to the adjacent bit.

9. The data processing circuit according to claim 6, wherein the at least one adjacent bit comprises a higher bit and a lower bit adjacent to the faulty bit, wherein the processor is further configured to:
determine a statistical value of a value of the first data at the higher bit and the lower bit, wherein the statistical value is the computed result.

10. The data processing circuit according to claim 9, wherein the statistical value is an arithmetic mean.
